(19) United States
(12) Patent Application Publication
(10) Pub. No.: US 2026/0117784 A1
(43) Pub. Date: Apr. 30, 2026

(54) LOW PITCH PROTECTION CONTROL SYSTEM

(71) Applicant: General Electric Company, Evendale, OH (US)

(72) Inventors: José Francisco Villarreal Valderrama, Querétaro (MX); Stefan Joseph Cafaro, Chapel Hill, NC (US); Logan Daniel Fritz, West Chester Township, OH (US); Gerardo Perez Perez, Querétaro (MX)

(21) Appl. No.: 19/057,705

(22) Filed: Feb. 19, 2025

Related U.S. Application Data
(60) Provisional application No. 63/555,618, filed on Feb. 20, 2024.

(51) Int. Cl. F04D 27/00; F04D 29/36

(52) U.S. Cl. CPC F04D 27/002; F04D 27/001; F04D 29/362

(57) ABSTRACT

A low pitch protection control system and method that includes sensing hardware, an engine controller, and a pitch actuation system for variable pitch fan blades of a turbine engine is provided. The engine controller receives sensed data from the sensing hardware related to current flight conditions, determines, based on at least some of the sensed data, a first pitch angle threshold value for initiating a first mitigating action to prevent onset of excessive drag at the current conditions, monitors a current pitch angle of one or more variable pitch fan blades of the turbine engine relative to the first pitch angle threshold value, and commands the pitch actuation system to perform the first mitigating action in response to the current pitch angle being less than or equal to the first pitch angle value.

### CROSS-REFERENCE TO RELATED APPLICATIONS

This application claims priority to U.S. Provisional Application No. 63/555,618, filed Feb. 20, 2024, the contents of which are incorporated herein by reference in their entirety.

### TECHNICAL FIELD

These teachings relate generally to jet engines and more particularly to a low pitch protection control system for use with variable pitch turbine engines.

### BACKGROUND

Aircrafts that employ turbine engines with variable pitch fan blades include full authority digital engine control (FADEC) systems that monitor conditions of the turbine engine and control the fan blade pitch to respond to and mitigate potentially hazardous flight conditions for the engine such as increased lateral aircraft instability from excessive drag. These systems typically use a single predetermined fan pitch threshold or fan rotation speed threshold to trigger mitigation measures, which is constant throughout the entire flight.

### BRIEF DESCRIPTION OF DRAWINGS

Various needs are at least partially met through provision of the low pitch protection control system described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a cross-sectional view of a gas turbine engine for an aircraft;

FIG. 2 is a block diagram of a low pitch protection control system in accordance with various embodiments;

FIG. 3 is a chart of fan pitch angle relative to thrust output of a turbofan engine in accordance with various embodiments;

FIG. 4 is a chart of fan pitch angle thresholds as a function of multiple turbofan engine parameters in accordance with various embodiments;

FIG. 5 is a flow diagram of a low pitch protection control method in accordance with various embodiments;

FIG. 6 is a simplified diagram of an angle of attack and a pitch angle of a fan blade of a turbine engine in accordance with various embodiments;

FIG. 7 is a flow diagram of a low pitch protection control process in accordance with various embodiments;

FIG. 8 is a chart of fan pitch angle relative to thrust margin of a turbofan engine in accordance with various embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

“Excessive drag”, also referred to herein as “limit drag” or Dₗᵢₘ, is when the drag force experienced by an aircraft exceeds the expected or acceptable levels of drag under normal operating conditions for a specific aircraft design, which can lead to hazardous or unsafe conditions of the aircraft as well as have detrimental effects on the aircraft's efficiency, range, speed, or fuel consumption.

The blade angle or pitch angle β of the fan blade is the angle between the chord line of the fan blade and the plane of rotation of the fan. The angle of attack α is defined as the angle between the chord line of the blade and the relative wind or airflow direction, which is a resultant vector of the rotational velocity and forward velocity of the aircraft.

The limit angle of attack αₗᵢₘ is the angle of attack that triggers excessive drag Dₗᵢₘ (e.g., at or below which excessive drag is generated).

NFₘₑₐₛ is the measured or current fan rotational speed, r is the fan radius, and the air speed is ambient wind velocity at operating conditions. In some approaches, air speed is determined as a product of the Mach number M and the speed of sound a (M*a).

A is the cross-sectional fan area and ρ is the air density at operating conditions. C_{T0} is the thrust coefficient at zero angle of attack (zero angle thrust; independent of the angle of attack) and C_{Tα} is the angle-dependent thrust coefficient. C_{T0} and C_{Tα} are calculated using either numerical simulations or experimental data once a propeller design is established.

ΔT_{lock} is the time it takes for the system described herein to execute a locking procedure and (ΔT_{lock}) ΔT_{feather} is the time it takes for the system described herein to execute a feathering procedure, from pitch detection to completion of locking or feathering, respectively.

Current monitoring and control systems for variable pitch turbine engine fan blades in aircraft aim to prevent dangerous conditions such as increased lateral instability due to excessive drag. These systems typically rely on a single, predetermined fan pitch threshold or fan rotation speed threshold to trigger mitigation measures to ensure safety of the aircraft. These predetermined thresholds are fixed throughout the entire flight envelope and do not take into account the dynamic nature of flight, ignoring variables like engine performance data, current speed, and atmospheric conditions. Further, such fixed thresholds are generally too restrictive for fan engines that not only have adjustable pitch blades but also operate at variable speeds. As a result, these rigid thresholds can lead to unnecessary activation of mitigation measures (false positives) or, conversely, a failure to engage them when truly needed (false negatives). These are all concerns with current control systems for variable pitch fan blade turbine engines with variable speed.

For example, consider a situation where a safety measure is triggered because the pitch angle of the fan blades falls below a preset threshold that remains constant across all phases of flight. This simplistic approach fails to account for the fact that safe minimum pitch angles can vary depending on the engine's rotational speed, engine performance, and the aircraft's specific flight conditions. In certain scenarios, a lower pitch angle than the preset threshold might be acceptable and not require any intervention. In these scenarios, unnecessary intervention to lock the pitch angle at a higher level or raise the pitch angle may reduce fuel efficiency. In other scenarios, a higher minimum pitch angle than the preset threshold might be necessary to prevent the onset of excessive drag and a potential hazardous condition.

The inventors have sought to improve upon control of variable fan blade pitch to improve engine efficiency and proactively avoid excessive drag. In doing so, the inventors have found that proactively controlling fan blade pitch during flight in response to various conditions of the flight and engine improves engine performance while avoiding excessive drag conditions. In particular, the inventors have found certain ranges of fan blade pitch values that avoid excessive drag while maintaining adequate efficiencies that change based on sensed current flight conditions. In another approach, the inventors have found that adjusting the fan blade pitch so that it is above a specific pitch threshold, which particular target threshold changes based on the sensed current conditions, results in avoiding excessive drag while optimizing engine efficiency.

Generally speaking, the various aspects of the present disclosure relate to a low pitch protection control system for use in variable pitch, variable speed turbine engines. The low pitch protection control system dynamically adapts to a wide array of operational variables during a flight, thereby ensuring the highest levels of safety and operational efficiency.

The low pitch protection control system integrates sensing hardware that monitors current operational conditions, an engine controller that processes this data to determine low pitch angle thresholds associated with excessive drag and determine whether mitigation measures are needed, and a pitch actuation system for fan blades of a turbine engine configured to adjust the pitch angle of the fan blades and implement the mitigation measures. In combination, these elements form an integrated system that provides real-time responsiveness and low pitch angle control in varying flight dynamics.

More specifically, the low pitch protection control system actively determines an optimal low pitch angle threshold for the fan blades for preventing excessive drag at each point during the flight. In practice, the low pitch angle threshold (also referred to herein as minimum pitch angle value or minimum pitch angle threshold) is the pitch angle value at which the fan blades can no longer generate effective thrust and avoid excessive drag. This dynamic threshold, which changes throughout the flight, is crucial in preventing the generation of excessive drag across the aircraft's entire range of operating conditions, known as the flight envelope. As used herein, “excessive drag”, also referred to herein as “limit drag”, is when the drag force experienced by an aircraft exceeds the expected or acceptable levels of drag under normal operating conditions for a specific aircraft design, which can lead to hazardous or unsafe conditions of the aircraft as well as have detrimental effects on the aircraft's efficiency, range, speed, or fuel consumption. The threshold at which drag becomes excessive drag or limit drag may differ for each aircraft type and may be determined by a set value tailored to the aircraft's engine and aerodynamic design. This limit is established to prevent the negative effects of high drag and should be adhered to during operation.

Unlike previous systems that rely on a fixed or static minimum pitch angle setting, the low pitch protection control system described herein continuously calculates and updates the low pitch angle threshold in response to real-time changes in operational variables and flight conditions. As a result, the system ensures that the fan blades maintain an angle that is both safe and efficient at every point during the flight.

In particular, the engine controller identifies a low pitch angle threshold value or minimum pitch angle threshold value based at least in part on local minimum pitch schedules along propeller maps, the thrust threshold of the aircraft, and a variety of input variables provided by the sensing hardware and/or advance ratio calculations relating to vectors for the forward thrust of the aircraft and rotation of the turbine engine fan section. The sensing hardware provides information on air data and engine cycle data to the engine controller. The engine controller uses the data from the sensing hardware and the identified minimum pitch schedules to monitor the current fan pitch relative to the identified minimum pitch value and command and control the pitch actuation system to institute various mitigation measures when the current pitch crosses or is near to the identified minimum pitch value. These mitigation measures as described below can include locking the pitch in a safe region and/or feathering the pitch (e.g. actively driving the fan pitch to a higher level).

Advantageously, the low pitch protection control system described herein provides a flexible in-flight low pitch threshold for thrust/power/torque controlled systems, which acts as a safeguard to prevent excessive drag generation at the fan blades and keeps the aircraft out of hazardous conditions such as lateral flight instability associated with excessive drag. Additionally, the low pitch protection control system described herein operates with an expanded engine flight envelope due to less restrictive constraints as compared with currently known systems and provides a dual actuation system for risk mitigation. Furthermore, the low pitch protection control system enables definition and optimization of power management schedules based on safety constraints. By controlling the pitch angle of the fan blades, the system can influence the engine's torque, which in turn affects the thrust the engine provides. As a result, the power needed for different flight conditions can be more accurately provided, ensuring the engine operates within the best range of speeds and blade angles for efficiency and safety.

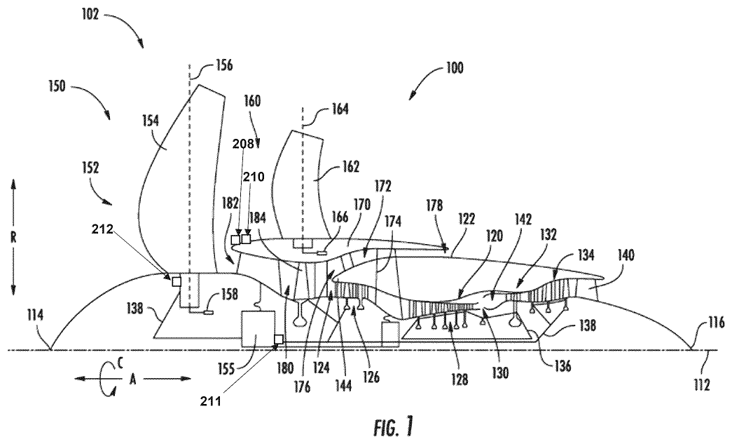

Referring now to FIG. 1, a schematic cross-sectional view of a gas turbine engine 100, for instance a single rotor, unducted, variable pitch, variable speed turbine engine is provided according to an example embodiment of the present disclosure.

It will be appreciated, however, that the example single rotor, unducted, variable pitch, variable speed engine 100 depicted in FIG. 1 is by way of example only, and that in other example embodiments, the engine 100 may have any other suitable configuration, including, for example, any other suitable number of shafts or spools, turbines, compressors, etc., a direct-drive configuration (i.e., may not include the gearbox 155); etc. For instance, in other example embodiments, the engine 100 may be a three-spool engine, having an intermediate speed compressor and/or turbine. In such a configuration, it will be appreciated that the terms “high” and “low,” as used herein with respect to the speed and/or pressure of a turbine, compressor, or spool are terms of convenience to differentiate between the components, but do not require any specific relative speeds and/or pressures, and are not exclusive of additional compressors, turbines, and/or spools or shafts.

Additionally, or alternatively, in other exemplary embodiments, any other suitable gas turbine engine with variable pitch fan blades may be provided. For example, in other exemplary embodiments, the gas turbine engine may be a turboshaft engine, a turboprop engine, a turbojet engine, a rotorcraft engine, a ducted engine with variable pitch blades, etc. Moreover, for example, although the engine is depicted as a single unducted rotor engine, in other embodiments, the engine may include a multi-stage open rotor configuration or a ducted engine, and aspects of the disclosure described herein below may be incorporated therein.

FIG. 1 illustrates the engine 100 having a rotor assembly with a single stage of unducted rotor blades. In such a manner, the rotor assembly may be referred to herein as an “unducted fan,” or the entire gas turbine engine 100 may be referred to as an “unducted engine,” or an engine having an open rotor propulsion system 102. In addition, the engine of FIG. 1 includes a mid-fan stream extending from the compressor section to a rotor assembly flowpath over the turbomachine, as will be explained in more detail below. It is also contemplated that, in other exemplary embodiments, the present disclosure is compatible with an engine having a duct around the fan. It is also contemplated that, in other exemplary embodiments, the present disclosure is compatible with a turbofan engine having a third stream as described hereinbelow.

For reference, the gas turbine engine 100 defines an axial direction A, a radial direction R, and a circumferential direction C. Moreover, the gas turbine engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The gas turbine engine 100 extends between a forward end 114 and an aft end 116, e.g., along the axial direction A.

The gas turbine engine 100 includes a turbomachine 120, also referred to as a core of the gas turbine engine 100, and a rotor assembly, also referred to as a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air and produce high energy combustion products.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a core or turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. As depicted, the fan 152 includes an array of fan blades 154. The fan blades 154 are rotatable, e.g., about the longitudinal axis 112. In FIG. 1, the fan 152 is drivingly coupled with the low pressure turbine 134 via the LP shaft 138. The fan 152 can be directly coupled with the LP shaft 138, e.g., in a direct-drive configuration. However, for the embodiments shown in FIG. 1, the fan 152 is coupled with the LP shaft 138 via a speed reduction gearbox 155, e.g., in an indirect-drive or geared-drive configuration.

Moreover, the fan blades 154 can be arranged in equal spacing around the longitudinal axis 112. Each fan blade 154 has a root and a tip and a span defined therebetween. Each fan blade 154 defines a central blade axis 156. For this embodiment, the fan blades 154 are variable pitch fan blades. Each fan blade 154 of the fan 152 is rotatable about its respective central blade axis 156, e.g., in unison with one another. One or more actuators 158 are provided to facilitate such rotation and therefore may be used to change a pitch of the fan blades 154 about their respective central blade axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about their respective central blade axis 164, e.g., in unison with one another. One or more actuators 166 are provided to facilitate such rotation and therefore may be used to change a pitch of the fan guide vane 162 about their respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the gas turbine engine 100 includes both a ducted and an unducted fan which both serve to generate thrust through the movement of air without passage through at least a portion of the turbomachine 120 (e.g., the HP compressor 128 and combustion section for the embodiment depicted). The ducted fan 184 may be at about the same axial location as the fan blade 154 or the vanes 162, and radially inward of the fan blade 154 or the vanes 162. The ducted fan 184, for the embodiment depicted, is driven by the low pressure turbine 134 (e.g., coupled to the LP shaft 138).

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan flow path or fan duct 172. The fan flowpath or fan duct 172 may be referred to as a third stream of the gas turbine engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl.

The gas turbine engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

With reference to FIGS. 1, 2, and 6, a low pitch protection control system 200 includes sensing hardware 202 for the turbine engine 100, an engine controller 204, and a pitch actuation system 206 for controlling the fan pitch actuators 158 and in turn the blade angle or pitch angle β of the fan blades 154 of the turbine engine 100.

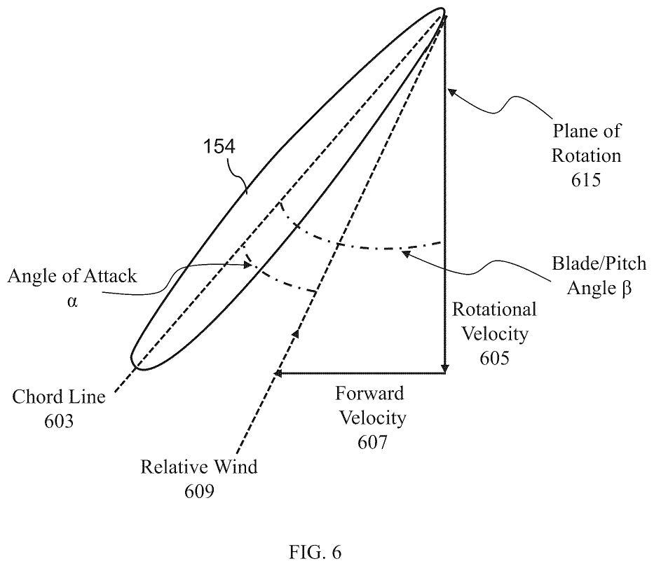

As shown in FIG. 6, the blade angle or pitch angle β of the fan blade 154 is the angle between the chord line 603 of the fan blade 154 and the plane of rotation 615, as is generally known in the art. Additionally, an angle of attack α is defined as the angle between the chord line 603 of the blade 154 and the relative wind 609 or airflow direction, which is a resultant vector of the rotational velocity 605 and forward velocity 607 of the aircraft. For variable pitch fan blades 154 in a turbine engine 100, the pitch angle β can be adjusted (e.g., via pitch actuators 158 of the pitch actuation system 206), which in turn alters the angle of attack α, to adjust the angle at which the blades 154 slice through the air. This affects how much air is moved and the level of thrust generated. By optimizing the angle of attack α in conjunction with the pitch angle 3, and, in particular, by determining low pitch thresholds for these angles, as described herein, the performance of the fan blades 154 can be finely tuned to various flight conditions and engine performance requirements.

The sensing hardware 202 includes one or a plurality of sensors to monitor real-time flight or operational conditions, providing current flight data to the low pitch protection control system 200. In some embodiments, for instance, the sensing hardware 202 includes one or more sensors that provide air data information. The air data sensors may for instance, include air speed sensors such as pressure anemometers or tube anemometers for sensing and/or determining a current air speed. In some approaches, these one or more sensors providing air data information may be mounted on the exterior of the aircraft. In some examples, the air data sensors may be mounted at the engine 100, for instance at portions of the engine that can provide dynamic and static pressure. In one non-limiting example, air data sensors such as a Mach number sensor 208 and an ambient static pressure sensor 210 are positioned at an upstream end of the fan cowl 170 (FIG. 1).

In some embodiments, the sensing hardware 202 includes a Mach number sensor 208 such as a pitot tube or similar device to determine a current Mach number, which represents the ratio of the aircraft's speed to the speed of sound. In one example, a pitot-static system may be used, which combines pitot tubes with static ports or ambient static pressure sensors 210 (e.g., resistive, capacitive, and/or piezoelectric). The pitot tubes measure the dynamic pressure (the pressure due to the aircraft's forward motion), while the static ports gauge the ambient static pressure (the atmospheric pressure unaffected by the aircraft's motion). Data from these sensors can be used to calculate air data properties such as the aircraft's air speed (i.e., ambient wind velocity at operating conditions, which may take into account altitude and temperature), Mach number, and altitude. Such calculations can be performed either by the Mach number sensor 208 itself or by the engine controller 204. Furthermore, to ensure accurate determination of air speed, Mach number, and other air properties, other sensing instruments may be employed. These can include temperature sensors such as total air temperature (TAT) probes, which measure the temperature of the air entering the aircraft's sensors, accounting for the temperature rise due to the aircraft's speed. The TAT probes may include, for example, thermocouples or resistance temperature detectors. Additionally, advanced technologies such as Doppler radar or GPS systems can offer alternative or supplementary methods to accurately estimate the aircraft's speed relative to the ground or through the air.

The sensing hardware 202, in some approaches, also includes a rotational speed sensor 211 for the fan 152, positioned to measure the current rotational fan speed throughout the flight. In some examples, the rotational speed sensor 211 is mounted in any location along the axis of the LP shaft 138 or at the speed reduction gearbox 155 (FIG. 1). Non-limiting examples include hall-effect sensors, inductive sensors, or eddy current sensors.

A pitch angle position sensor 212 positioned to measure the current pitch angle β of the fan blades 154 of the fan 152 may also be included. The pitch angle position sensor 212 may be mounted at a root of the fan blades 154 (e.g., as shown in FIG. 1) using a magnetic sensor or in the pitch actuator 158 using a position sensor. In a non-limiting embodiment, a variable differential transducer is employed, which measures the position of the actuator 158 as a proxy to blade pitch.

The sensing hardware 202 is operatively coupled to a processor 214 of the engine controller 204 so that the processor 214 can receive data therefrom indicative of the current flight or operational conditions of the turbine engine 100 including, for example, the current Mach number of the aircraft from the Mach number sensor 208, the current ambient static pressure from the ambient static pressure sensor 210, the current rotational speed of the fan 152 from the rotational speed sensor 211, and/or the current pitch angle of the fan 152 from the pitch angle position sensor 212. In some approaches, the air speed or velocity and/or the Mach number are calculated from data received from the sensing hardware 202 at the engine controller 204. Other data such as temperature, altitude, air viscosity, air density, etc. may be received from the sensors or calculated from data received from the sensors.

In some embodiments, the engine controller 204 includes a full authority digital engine controller (FADEC) that includes the processor 214 and a memory 216 having one or more program instructions stored thereon. The one or more program instructions may be executable by the processor 214 to perform the methods described herein and/or other general functions for the turbine engine 100 and/or the aircraft utilizing the turbine engine 100. The processor 214 may include, for example, a microprocessor, a system-on-a-chip, an application specific integrated circuit (ASIC), and/or a field programmable gate array (FPGA). The memory 216 may include, for example, an electrical charge-based storage media such as electrically erasable programmable read-only memory (EEPROM) or random access memory (RAM), or other non-transitory computer readable media such as an optical or magnetic based storage device.

The FADEC system generally has full authority over operating parameters of the turbine engine 100 and cannot be manually overridden. The FADEC generally functions by receiving a plurality of input variables of a current flight including, but not limited to, air density, throttle lever position, engine temperature, engine pressure, and/or the like. In addition, to enable the low pitch protection control system 200, the input variables may also include the outputs of the sensing hardware 202 described herein and/or other sensors.

The inputs are received, analyzed, and used to determine operating parameters such as, but not limited to, fuel flow, stator vane position, bleed valve position, and/or the like. The FADEC can also control a start and/or a restart operation of the turbine engine 100. In addition, one or more of the inputs can be received, analyzed, and used to determine whether a current pitch angle β of the fan blades 154 at a certain point during the flight is sufficient to prevent excessive drag or whether low pitch control measures need to be activated, as described further below.

The pitch actuation system 206 is electrically coupled to the processor 214 and is configured to translate electrical signals and operating commands received by the processor 214 into mechanical and/or pneumatic motion of the actuators 158 so as to control the pitch of the fan 152 (e.g. to drive the pitch to a specific value, freeze or lock the pitch at a specific value, etc.).

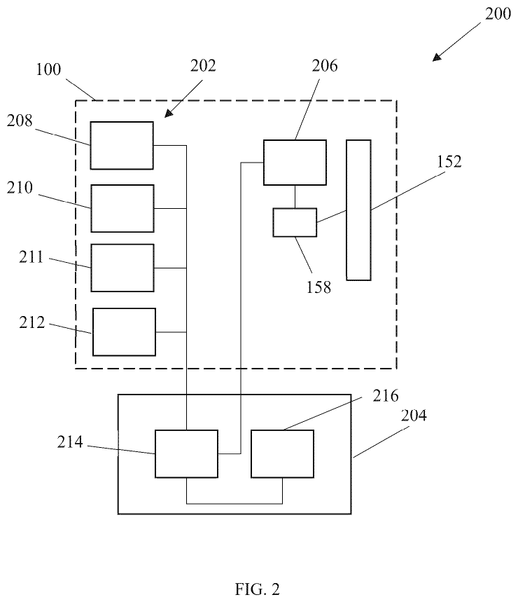

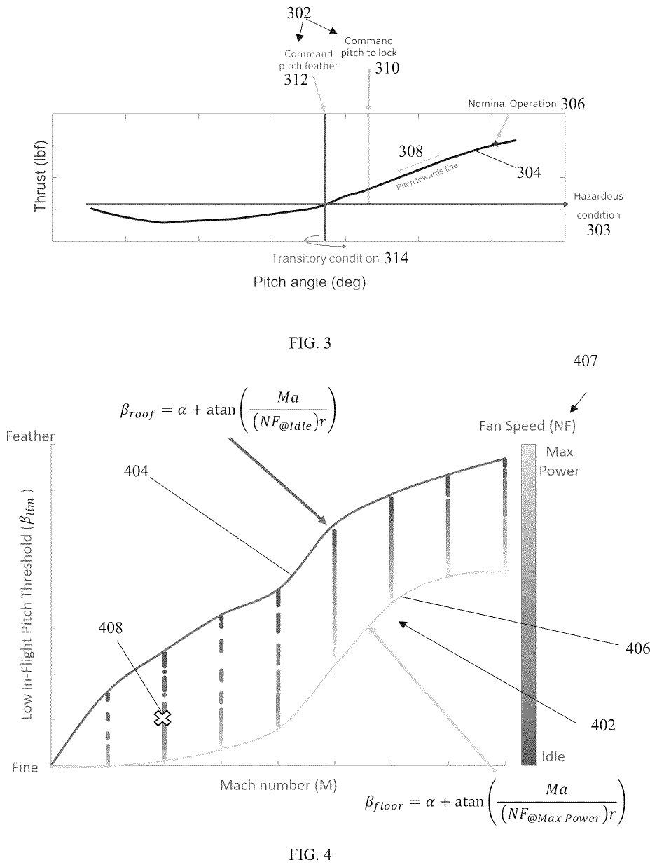

Operation of the low pitch protection control system 200 according an embodiment will be discussed with reference to FIGS. 2 and 3. As described above, the processor 214 receives the data from the sensing hardware 202, for instance, air speed or Mach number data, pressure data, fan pitch angle data, and/or fan rotational speed data. Then, using the data received from the sensing hardware 202 and the instructions stored in the memory 216, the processor 214 identifies and/or computes one or more minimum pitch angle values 302 based on the data from the sensing hardware 202 to serve as trigger points or thresholds for activating mitigation measures to prevent excessive drag generation from occurring and a hazardous condition 303 for the aircraft.

As shown in FIG. 3, the processor 214 monitors the current pitch angle 304 of the fan 152, via data received from the pitch angle position sensor 212, relative to a nominal operating condition 306. As the pitch angle 304 trends in a direction 308 towards fine (e.g. a low pitch angle relative to the nominal operating condition 306), the processor 214 can initiate a pitch lock mitigation measure 310 when a first one of the one or more minimum pitch angle values 302 is reached. The pitch lock mitigation measure 310, in some situations, commands the pitch actuation system 206 to lock the pitch 304 of the fan 152 at its current level using the actuators 158 and prevent the turbine engine 100 and aircraft from reaching a hazardous condition 303, which may, for instance, be a result of generation of excessive drag.

Additionally or alternatively, the processor 214 can instigate a pitch feather mitigation measure 312 when a first or a second one of the one or more minimum pitch values 302 is reached. The pitch feather mitigation measure 312 directs the pitch actuation system 206 to enter a transient state 314 where the pitch angle 304 is actively driven by the actuators 158 to a higher level above the hazardous condition 303 (e.g. the level for the nominal operating condition 306 or similar). Feathering includes rotating the blades 154 towards a higher angle, effectively presenting the edge of the blade to the oncoming air rather than the face (for example, to or towards a pitch angle of 90 degrees). This position reduces the resistance on the fan blades 154 and prevents windmilling of the fan 152, lessening the drag.

The low pitch protection control system 200 can be configured to utilize one or both of the pitch lock mitigation measure 310 and the pitch feather mitigation measure 312 as well as other corrective mitigation measures to prevent excessive drag and prevent or minimize the hazardous condition 303. Specifically, the pitch feather mitigation measure 312 can be used in addition to the pitch lock mitigation measure 310 in situations where the pitch 304 continues to decline following activation of the pitch lock mitigation measure 310, such as due to engine failure. However, the pitch feather mitigation measure 312 or the pitch lock mitigation measure 310 can also be used as the sole mitigation measure of the low pitch protection control system 200.

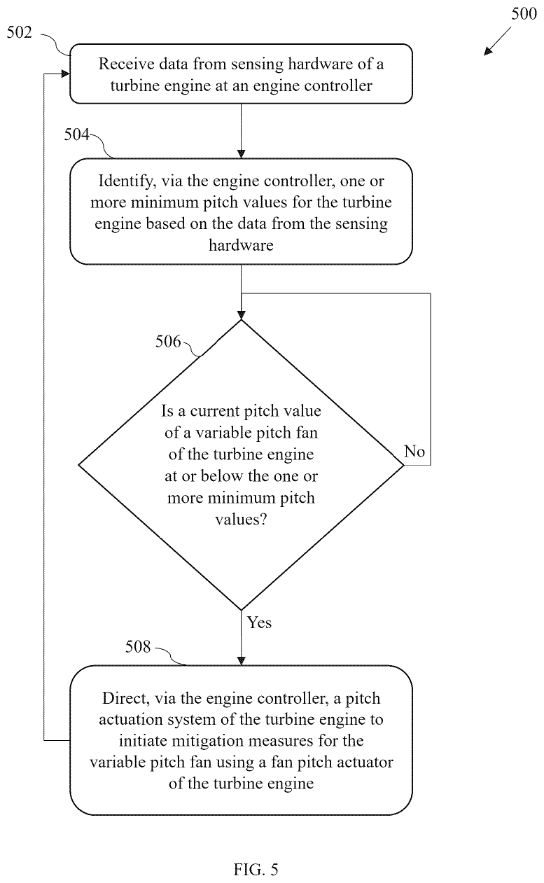

With reference now to FIGS. 2 and 5, a low pitch protection control method 500, that may be used to operate the low pitch protection control system 200 according to an embodiment includes the following steps. At step 502, the method 500 includes receiving data from the sensing hardware 202 at the engine controller 204. Then, at step 504, the method 500 includes identifying, via the engine controller 204, one or more minimum or threshold pitch values for the turbine engine 100 based on the data from the sensing hardware 202. Next, at step 506, the engine controller 204 determines whether a current pitch angle value of the fan 152 is at or below the one or more minimum pitch values. In response to when the current pitch angle value of the fan 152 is not at or below the one or more minimum pitch values, the method 500 includes continuing to determine whether current pitch angle value of the fan 152 is at or below the one or more minimum pitch values. However, in response to when the current pitch angle value of the fan 152 is at or below the one or more minimum pitch values, the method 500 includes, at step 508, directing, via the engine controller 204, the pitch actuation system 206 to initiate mitigation measures for the fan 152 using the actuators 158. After the mitigation measure, the method 500 operates on a loop to provide continued monitoring and pitch angle adjustments for the entire duration of a flight.

In some approaches, the processor 214 of the low pitch protection control system 200 determines the one or more minimum pitch angle values 302 based at least on the current rotational fan speed of the fan 152. In variable-pitch, variable-speed engines, one of the factors that influences the minimum pitch angle value is the fan blade speed. For instance, at higher rotational fan speeds, a finer pitch can often be used without incurring excessive drag, as the relative airflow is sufficient to ensure efficient blade performance. At lower rotational fan speeds, however, a finer pitch risks creating excessive drag due to windmilling, where the fan blades 154, resembling flat plates, disrupt airflow and increase resistance. To counteract this, the inventors found that at lower speeds it is important to adjust the one or more minimum pitch angle values 302 to a higher minimum threshold to maintain an angle that encourages smooth airflow and minimizes drag. At higher rotational speeds, in turn, the one or more minimum pitch angle values 302 can often be lower and still maintain sufficient thrust. This adjustable threshold ensures optimal performance across varying speeds, preserving aircraft control and efficiency, especially in non-thrust or emergency conditions.

In some approaches, the processor 214 of the low pitch protection control system 200 may also determine the one or more minimum pitch angle values 302 based at least on the current air speed and/or the current Mach number in the current operational conditions. One or more minimum pitch angle values 302 may additionally be based on characteristics of the fan blade design (e.g., a radius, a cross-sectional area), thrust coefficients associated with the fan blades, a predetermined drag limit, other air attributes such as air density and altitude, and an angle of attack determined from one or more of these values.

As shown in FIG. 4, the one or more minimum pitch angle values 302 (FIG. 3) calculated or identified by the processor 214 (FIG. 2) may be within a range 402 or spread of possible minimum pitch angle values that vary based on factors such as the blade design (e.g., based on performance maps or operating charts associated with a blade design) and/or operational conditions received from the sensing hardware 202 such as Mach number and rotational fan speed.

In designing the low pitch protection control system 200, the inventors developed a set of control system 200 configurations generating minimum or threshold pitch angle values 302 throughout a flight for preventing excessive drag, specifically by determining a limit pitch angle value βₗᵢₘ which defines a threshold pitch angle value at or below which excessive drag Dₗᵢₘ is generated. More specifically, βₗᵢₘ is based in part on a limit angle of attack αₗᵢₘ, which is the angle of attack that triggers excessive drag Dₗᵢₘ (e.g., at or below which excessive drag is generated).

Developing an effective system to maximize thrust and define power management in turbine engines with variable pitch fan blades and variable speeds demanded a substantial investment of time and labor. The inventors' approach required a detailed analysis of how aerodynamic and mechanical factors influence fan blade performance and thrust generation during flight, and how to determine flexible low pitch angle thresholds that are integrated with system hardware to provide real-time, effective in-flight low pitch control. Specifically, the inventors performed extensive computational fluid dynamics (CFD) and high-fidelity simulations such as using Numerical Propulsion System Simulation (NPSS) to determine αₗᵢₘ and threshold pitch angle values that prevent excessive drag in various operational conditions, such as βₗᵢₘ, the threshold limit pitch angle value at or below which excessive drag is generated that is based on certain engine design and flight conditions, β_{lock}, the pitch angle value that triggers locking, and β_{feather}, the pitch angle value that triggers feathering.

Using this design practice, the inventors found system configurations with acceptable and unacceptable drag conditions relative to αₗᵢₘ values and corresponding values of Mach number (M), the current measured fan rotational speed (NFₘₑₐₛ), and altitude (Alt), shown in Table 1. Examples 1-15 show acceptable combinations of configurations and flight conditions that represent when excessive drag is triggered relative to the operational conditions. Maintaining the angle of attack above these values prevented excessive drag. Examples 16-20 show unacceptable combinations of configurations and flight conditions that do not represent when excessive drag is triggered relative to the operational conditions. The examples use a fixed propeller design (e.g., fixed r, A, C_{T0}, and C_{Tα}, which values are fixed based upon a given propeller design). Specifically, the fan radius r is 6.45 ft.

TABLE 1

| | αₗᵢₘ | NFₘₑₐₛ | | Alt |
|---|---|---|---|---|
| | (deg) | (rads/s) | M | (ft) |
| Example 1 | −25.30 | 32.98 | 0.3 | 0 |
| Example 2 | −25.30 | 32.98 | 0.3 | 20,000 |
| Example 3 | −19.82 | 52.98 | 0.2 | 40,000 |
| Example 4 | −4.73 | 76.52 | 0.6 | 0 |
| Example 5 | −20.50 | 106.81 | 0.4 | 20,000 |
| Example 6 | −19.34 | 117.30 | 0.4 | 40,000 |
| Example 7 | −8.86 | 100.60 | 0.1 | 0 |
| Example 8 | −9.49 | 41.20 | 0.7 | 20,000 |
| Example 9 | −2.11 | 88.30 | 0.7 | 40,000 |
| Example 10 | −10.62 | 64.75 | 0.5 | 0 |
| Example 11 | −5.88 | 52.98 | 0.8 | 20,000 |
| Example 12 | −12.66 | 41.20 | 0.1 | 40,000 |
| Example 13 | −7.54 | 97.42 | 0.5 | 0 |
| Example 14 | −14.51 | 100.60 | 0.2 | 20,000 |
| Example 15 | −14.19 | 32.98 | 0.6 | 40,000 |
| Example 16 | −30.3 | 32.98 | 0.3 | 0 |
| Example 17 | −27.2 | 32.98 | 0.3 | 20,000 |
| Example 18 | 5.4 | 52.98 | 0.2 | 40,000 |
| Example 19 | −8.6 | 76.52 | 0.6 | 0 |
| Example 20 | −25.5 | 106.81 | 0.4 | 20,000 |

Examples 1-15 represent system configurations having angles of attack that prevent excessive drag from occurring relative to operational conditions. From these examples, the inventors determined that a threshold limit pitch angle value βₗᵢₘ could be characterized in Equation 1 based on the above parameters, the threshold limit pitch angle value βₗᵢₘ being the pitch angle at or below which excessive drag is generated relative to current operational conditions:

$${β}_{lim} = {α}_{lim} + a tan ( \frac{Ma}{( {NF}_{meas} ) r} ) \qquad Equation 1$$

where r is the fan radius, NFₘₑₐₛ is the measured or current fan rotational speed, M is the Mach number, a is the speed of sound, and αₗᵢₘ is the limit angle of attack as defined above.

Based on Equation 1, the βₗᵢₘ values for Examples 1-20 are shown in Table 2, below. The βₗᵢₘ values in Examples 1-15 prevent excessive drag and the βₗᵢₘ values in Examples 16-20 do not prevent excessive drag.

TABLE 2

| | αₗᵢₘ | NFₘₑₐₛ | | Alt | βₗᵢₘ |
|---|---|---|---|---|---|
| | (deg) | (rads/s) | M | (ft) | (deg) |
| Example 1 | −25.30 | 32.98 | 0.3 | 0 | 32.26 |
| Example 2 | −25.30 | 32.98 | 0.3 | 20,000 | 28.45 |
| Example 3 | −19.82 | 52.98 | 0.2 | 40,000 | 9.69 |
| Example 4 | −4.73 | 76.52 | 0.6 | 0 | 48.86 |
| Example 5 | −20.50 | 106.81 | 0.4 | 20,000 | 10.52 |
| Example 6 | −19.34 | 117.30 | 0.4 | 40,000 | 7.74 |
| Example 7 | −8.86 | 100.60 | 0.1 | 0 | 0.89 |
| Example 8 | −9.49 | 41.20 | 0.7 | 20,000 | 60.38 |
| Example 9 | −2.11 | 88.30 | 0.7 | 40,000 | 47.82 |
| Example 10 | −10.62 | 64.75 | 0.5 | 0 | 42.55 |
| Example 11 | −5.88 | 52.98 | 0.8 | 20,000 | 61.71 |
| Example 12 | −12.66 | 41.20 | 0.1 | 40,000 | 7.34 |
| Example 13 | −7.54 | 97.42 | 0.5 | 0 | 34.05 |
| Example 14 | −14.51 | 100.60 | 0.2 | 20,000 | 0.21 |
| Example 15 | −14.19 | 32.98 | 0.6 | 40,000 | 55.68 |
| Example 16 | −30.3 | 32.98 | 0.3 | 0 | 30.20 |
| Example 17 | −27.2 | 32.98 | 0.3 | 20,000 | 25.4 |
| Example 18 | 5.4 | 52.98 | 0.2 | 40,000 | 7.7 |
| Example 19 | −8.6 | 76.52 | 0.6 | 0 | 40.8 |
| Example 20 | −25.5 | 106.81 | 0.4 | 20,000 | 6.5 |

In addition, the limit pitch angle value βₗᵢₘ as expressed in Equation 1 has an upper bound 404 associated with a near idle state of the fan 152 of the turbine engine 100 and a lower bound 406 associated with a full throttle or maximum power state of the fan 152 of the turbine engine 100, as shown in FIG. 4 (see e.g. the fan speed key legend 407). In particular, the upper bound 404 or β_{roof} is defined by Equation 2 below in which β_{roof} is the upper limit for βₗᵢₘ at a specific point of the flight envelope defined when the fan rotational speed NF is in a near idle or idle state, and the lower bound 406 or β_{floor} is defined by Equation 3 below in which β_{floor} is the lower limit for βₗᵢₘ at a specific point of the flight envelope defined when the fan rotational speed NF is at maximum power.

$${β}_{roof} = {α}_{lim} + a tan ( \frac{M a}{( {NF}_{idle} ) r} ) \qquad Equation 2$$

$${β}_{floor} = {α}_{lim} + a tan ( \frac{M a}{( {NF}_{mp} ) r} ) \qquad Equation 3$$

As shown in FIG. 4, the β_{roof} and β_{floor} values vary relative to the currently sensed Mach number. More generally, the β_{roof} and β_{floor} values vary relative to the air speed, as well as to any of the flight, operational, or design variables present in Equation 1. The inventors have determined that in operation, at any given point within a flight, the calculated βₗᵢₘ should always be a value between the β_{roof} and β_{floor} values to provide sufficient engine efficiency while avoiding excessive drag.

In one approach, the limit pitch angle value βₗᵢₘ defined by Equation 1 and determined by the system 200 may itself serve as a minimum pitch angle value threshold for mitigation measures such as locking or feathering to occur. For instance, in this approach, when the current pitch angle of the fan blades 154 is approaching (e.g., within a predefined distance from) the limit pitch angle value βₗᵢₘ, the system 200 may initiate locking or feathering. For instance, as shown in the graph illustrated in FIG. 4, in operation, the processor 214 (FIG. 2) uses Equation 1 to calculate the limit pitch angle value βₗᵢₘ at a given point during the flight using current values from the sensing hardware 202, shown on the graph as value 408. This value 408 is between the upper bound 404 and the lower bound 406, that is, between β_{roof} and β_{floor}, and is the threshold pitch angle value βₗᵢₘ at or below which excessive drag would be generated given the current flight and operational conditions. Using the mathematical relationships described herein keyed to the data received from the sensing hardware 202 (FIG. 2) to determine the limit pitch angle value βₗᵢₘ at a particular point in the flight provides for a more flexible and reliable approach as compared with simply setting a static minimum pitch value 410 for triggering mitigation measures such as locking or feathering. Specifically, as shown in FIG. 4, this approach reduces or eliminates false negative activation of the mitigation measures based on pitch values 412 falling below the static minimum pitch value 410 and false positive activation of the mitigation measures based on pitch values 414 falling above the static minimum pitch value 410.

Further, as shown in FIG. 4 and expressed in Equation 1, the βₗᵢₘ value 408 is based at least in part on the current Mach number of the aircraft as received from the Mach number sensor 208 and the current rotational speed of the fan 152 as received from the rotational speed sensor 211. It will also be appreciated that additional variables such as the value from the ambient static pressure sensor 210 or other sensors of the sensing hardware 202 can define parameters used to determine the value 408.

In another approach, the system 200 can determine one or more additional pitch angle value thresholds that incorporate a pitch angle margin above the limit pitch angle value βₗᵢₘ to account for the system hardware's responsiveness, such as its slew rate. This ensures that the system 200 has sufficient time to execute mitigation measures before the limit pitch angle value βₗᵢₘ is reached. This approach introduces a swift, real-time pitch control capability that is seamlessly integrated with the system hardware, ensuring both immediate response and precise execution of the pitch control measures.

For instance, a pitch angle value threshold β_{lock} is determined, defining the pitch angle value threshold at which the locking measure should occur. That is, when the current pitch angle being monitored is less than or equal to β_{lock}, locking is initiated. This provides enough margin for the system hardware to respond and execute the locking procedure prior to the limit pitch angle value βₗᵢₘ being reached and the occurrence of excessive drag. In addition, in some approaches, a pitch angle value threshold β_{feather} may additionally or alternatively be determined, defining the pitch angle value threshold at which the feathering measure should occur. That is, when the current pitch angle being monitored is less than or equal to β_{feather}, feathering is initiated. This provides enough margin for the system hardware to respond and execute the feathering procedure prior to the limit pitch angle value βₗᵢₘ being reached and the occurrence of excessive drag.

For instance, in one approach β_{feather} and β_{lock} are based in part on a slew rate of the system 200, which represents the minimum rate at which the system 200 must execute the locking procedure without reaching the limit angle of attack αₗᵢₘ (and the limit pitch angle βₗᵢₘ) that results in limit or excessive drag. In this approach, the system hardware of the system 200 is configured to have a minimum slew rate that permits sufficient time for the locking procedure to occur without resulting in the limit angle of attack corresponding to excessive drag. The slew rate for the system 200 in this approach is determined by Equation 4 below:

$$\dot{α} = \frac{Δα}{Δ {T}_{lock}} \qquad Equation 4$$

where α is the minimum slew rate, Δα is the change in angle of attack from the design operating condition to the limit angle of attack αₗᵢₘ triggering limit drag (e.g., the amount the angle of attack can drift before triggering excessive drag), and ΔT_{lock} is the time it takes for the system 200 to execute the locking procedure from pitch detection to completion of locking. For instance, ΔT_{lock} combines the time required to detect a low pitch angle, command the mitigation hardware activation, and complete the locking procedure, accounting for any mechanical gaps and hydraulically induced delays in the system, the impact of refresh time, and margin to compensate for input sensor noise.

In addition, Δα is determined by Equation 5 below:

$$\frac{Δ F}{\frac{1}{2} ρ {NF}_{meas}^{2} {r}^{2} {AC}_{T α}} = Δ α \qquad Equation 5$$

where all the terms in this equation are the same as the definitions provided above, and ΔF is the difference between the design thrust and the limit drag (F_{design}−Dₗᵢₘ=ΔF), representing how much the design thrust exceeds the limit drag and thus how much margin of thrust is available beyond what is required to counteract the limit drag. To derive the minimum slew rate a in Equation 4, a minimum possible Δα is input into the equation, representing the least amount of angle change margin available before reaching the limit angle of attack αₗᵢₘ triggering limit drag. By designing the slew rate for the smallest Δα, this sets the system's slew rate to be fast enough for the most time-sensitive adjustments (e.g., in which the system has the least amount of angle change margin to execute locking), thereby providing a single value for the slew rate that will be adequate for all possible changes in angle of attack.

The minimum pitch angle value threshold β_{feather} is expressed as a function of the slew rate a as in Equation 6 below:

$${β}_{feather} = {β}_{lim} + Δ {T}_{feather} * \dot{α} \qquad Equation 6$$

where β_{feather} is the minimum pitch angle value threshold at which the feathering measure should occur given the slew rate a of the system, βₗᵢₘ, and ΔT_{feather}, the time it takes to execute the pitch feathering procedure. As shown in this relationship, it will be appreciated that β_{feather} is greater than βₗᵢₘ so that feathering is initiated at a high enough pitch angle to provide time for the feathering to be implemented prior to the pitch reaching βₗᵢₘ.

The minimum pitch angle value threshold β_{lock} is also expressed as a function of the slew rate a as in Equation 7 below:

$${β}_{lock} = {β}_{feather} + Δ {T}_{lock} * \dot{α} \qquad Equation 7$$

where β_{lock} is the minimum pitch angle value threshold at which the locking measure should occur given the slew rate a of the system, β_{feather}, and ΔT_{lock}, the time it takes to execute the pitch locking procedure. As shown in this relationship, it will be appreciated that β_{lock} is greater than β_{feather}. Thus, in a system 200 that includes a first locking procedure and a second feathering procedure if the locking procedure fails, β_{lock} includes additional margin on top of β_{feather} to provide sufficient time for locking to occur before β_{feather} is reached.

It will further be appreciated that in a system 200 that includes a locking measure but does not include a feathering measure, the value of β_{feather} in Equation 7 is simply equal to βₗᵢₘ.

Based on Equations 6 and 7, the β_{lock} and β_{feather} values for Examples 1-20 are shown in Table 3, below. The β_{lock} and β_{feather} values in Examples 1-15 prevent excessive drag when implemented in a low pitch protection system 200 configured to deploy mitigation measures at β_{lock} or β_{feather} prior to αₗᵢₘ and βₗᵢₘ being reached. The β_{lock} and β_{feather} values in examples 16-20 do not prevent excessive drag when implemented in a low pitch protection system 200 configured to deploy mitigation measures prior to αₗᵢₘ and βₗᵢₘ being reached. These examples have a slew rate of 20 deg/s, ΔT_{lock} equal to 0.25 s, and a ΔT_{feather} equal to 0.205 s.

TABLE 3

| | αₗᵢₘ | NFₘₑₐₛ | | Alt | βₗᵢₘ | β_{feather} | β_{lock} |
|---|---|---|---|---|---|---|---|
| | (deg) | (rads/s) | M | (ft) | (deg) | (deg) | (deg) |
| Example 1 | −25.30 | 32.98 | 0.3 | 0 | 32.26 | 36.36 | 41.36 |
| Example 2 | −25.30 | 32.98 | 0.3 | 20,000 | 28.45 | 32.55 | 37.55 |
| Example 3 | −19.82 | 52.98 | 0.2 | 40,000 | 9.69 | 13.79 | 18.79 |
| Example 4 | −4.73 | 76.52 | 0.6 | 0 | 48.86 | 52.96 | 57.96 |
| Example 5 | −20.50 | 106.81 | 0.4 | 20,000 | 10.52 | 14.62 | 19.62 |
| Example 6 | −19.34 | 117.30 | 0.4 | 40,000 | 7.74 | 11.84 | 16.84 |
| Example 7 | −8.86 | 100.60 | 0.1 | 0 | 0.89 | 4.99 | 9.99 |
| Example 8 | −9.49 | 41.20 | 0.7 | 20,000 | 60.38 | 64.48 | 69.48 |
| Example 9 | −2.11 | 88.30 | 0.7 | 40,000 | 47.82 | 51.92 | 56.92 |
| Example 10 | −10.62 | 64.75 | 0.5 | 0 | 42.55 | 46.65 | 51.65 |
| Example 11 | −5.88 | 52.98 | 0.8 | 20,000 | 61.71 | 65.81 | 70.81 |
| Example 12 | −12.66 | 41.20 | 0.1 | 40,000 | 7.34 | 11.44 | 16.44 |
| Example 13 | −7.54 | 97.42 | 0.5 | 0 | 34.05 | 36.36 | 41.36 |
| Example 14 | −14.51 | 100.60 | 0.2 | 20,000 | 0.21 | 32.55 | 37.55 |
| Example 15 | −14.19 | 32.98 | 0.6 | 40,000 | 55.68 | 13.79 | 18.79 |
| Example 16 | −30.3 | 32.98 | 0.3 | 0 | 30.20 | 34.3 | 39.3 |
| Example 17 | −27.2 | 32.98 | 0.3 | 20,000 | 25.4 | 29.5 | 34.5 |
| Example 18 | 5.4 | 52.98 | 0.2 | 40,000 | 7.7 | 11.8 | 16.8 |
| Example 19 | −8.6 | 76.52 | 0.6 | 0 | 40.8 | 44.9 | 49.9 |
| Example 20 | −25.5 | 106.81 | 0.4 | 20,000 | 6.5 | 10.6 | 15.6 |

Furthermore, the values of the parameters, according to the system configurations described herein, are within the ranges defined in Table 4, below:

TABLE 4

| | Min | Max |
|---|---|---|
| αₗᵢₘ (deg) | −30 | 10 |
| \dot{α} (deg/s) | 0 | 50 |
| Dₗᵢₘ (lbf) | 0 | 14,000 |
| ρ (lbm/ft³) | 0 | 0.07967 |
| NF (rads/s) | idle | Max power |
| r (ft) | 0 | 14 |
| A (ft²) | 0 | 615.75 |
| C_{T0} | 0 | 1 |
| C_{Tα} | 0 | 1 |
| Δα (deg) | 0 | 90 |
| ΔT_{lock} (s) | 0 | 1 |
| ΔT_{feather} (s) | 0 | 1 |
| Mach Number (M) | 0 | 0.9 |
| βₗᵢₘ (deg) | 0 | 90 |
| β_{lock} (deg) | 0 | 90 |
| β_{feather} (deg) | 0 | 90 |

In addition, βₗᵢₘ can be defined by Equation 8, below:

$${α}_{lim} = \frac{[ \frac{2 {D}_{lim}}{ρ {NF}_{meas}^{2} {r}^{2} A} - {C}_{T 0} ]}{{C}_{T α}} \qquad Equation 8$$

In some approaches Equation 8 is used by the processor 214 to determine the αₗᵢₘ. However, in other approaches, αₗᵢₘ may be determined by a lookup table that is populated with limit angle of attack αₗᵢₘ values pre-determined for a given design relative to specific operational conditions. For instance, in one specific implementation the lookup table includes αₗᵢₘ values based on current Mach number and current rotational speed, and the αₗᵢₘ is selected from the table by the processor 214 based on current Mach number and current rotational speed. Such αₗᵢₘ values are simplified αₗᵢₘ values based on Equation 8 and assuming the other parameters in the equation are constant, to provide a simplified processing approach.

Equation 8 is derived in part by the relationship between limit drag Dₗᵢₘ and thrust. For instance, Equation 9, below, represents the relationship between Dₗᵢₘ and thrust Tₚᵣₒₚ, where Tₚᵣₒₚ is the thrust generated by the blades.

$${D}_{lim} - {T}_{prop} = 0 \qquad Equation 9$$

Thrust Tₚᵣₒₚ is related to fan blade characteristics and other parameters in the following relationships as expressed by Equation 10:

$${T}_{prop} = \frac{1}{2} ρ {NF}_{meas}^{2} {r}^{2} {AC}_{T} \qquad Equation 10$$

where r is the fan radius, NFₘₑₐₛ is the current measured fan rotational speed, ρ is the air density at operating conditions, A is the cross-sectional fan area, and C_{T} is the thrust coefficient of a specific fan blade design. More specifically, C_{T} is equal to the sum of C_{T0}, the thrust coefficient at zero angle of attack (zero angle thrust; independent of the angle of attack), and the product of the angle of attack α and C_{Tα}, the angle-dependent thrust coefficient, as expressed by Equation 11:

$${C}_{T} = {C}_{T 0} + {C}_{T α} α \qquad Equation 11$$

Equation 8, which defines αₗᵢₘ, is derived from these relationships expressed in Equations 9, 10, and 11.

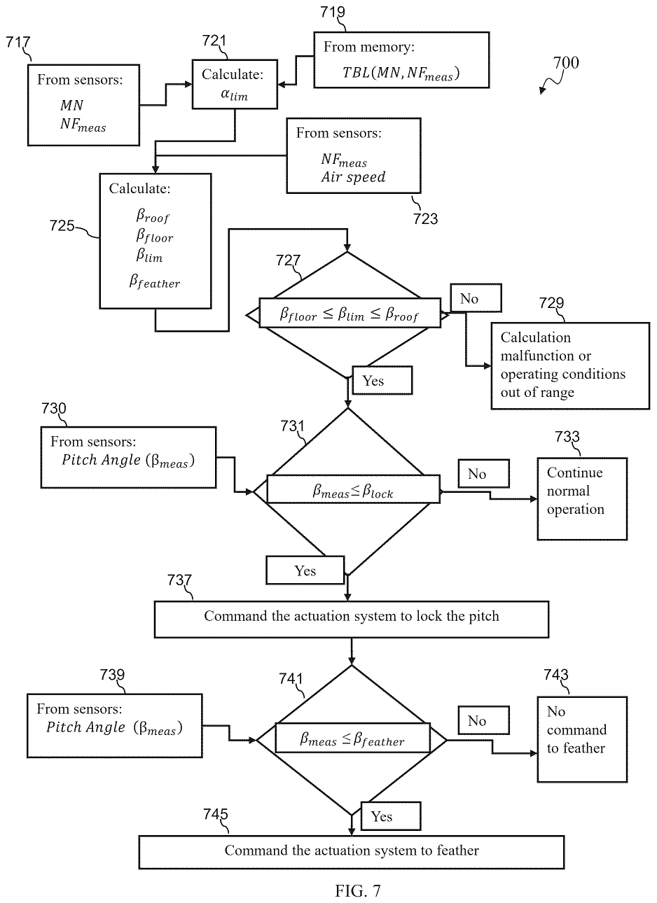

With reference to FIGS. 2 and 7, an example process 700 for operating the low pitch protection control system 200 has the following steps. The process 700 includes receiving 717, at the processor 214, inputs from the sensing hardware 202, such as the current Mach number and the current fan rotational speed NFₘₑₐₛ. The process 700 includes a step 719 of retrieving from the memory 216 a look-up table that relates αₗᵢₘ to Mach number and fan rotational speed. These table values, in some approaches, can be based on the relationships defined in Equation 8. At step 721, the limit angle of attack αₗᵢₘ for the current flight conditions is determined or calculated by the processor 214 using the inputs from the sensing hardware 202 and the table. In some approaches, Equation 8 is used to calculate αₗᵢₘ, using the inputs from the sensing hardware 202.

At step 723, inputs from the sensors, such as the current fan rotational speed NFₘₑₐₛ and the air speed or the Mach number is retrieved to be input into further calculations at 725. Specifically, β_{roof}, β_{floor}, βₗᵢₘ, β_{lock}, and β_{feather} are determined from the sense inputs and from the current limit angle of attack αₗᵢₘ. These β values are determined by the relationships expressed in Equations 1, 2, 3, 6, and 7.

At step 727, the βₗᵢₘ value is compared to β_{roof} and β_{floor} to determine whether βₗᵢₘ is between these two bounds. If βₗᵢₘ is not greater than or equal to β_{floor} and/or not less than or equal to β_{roof}, this indicates a calculation malfunction 729 or that the operating conditions are out of range, which could result in attempted recalculations. If βₗᵢₘ is greater than or equal to β_{floor} and less than or equal to β_{roof}, the process 700 continues to steps 730 and 731.

At step 730, the current pitch angle βₘₑₐₛ is received from the sensing hardware 202 and compared, at step 731, to β_{lock} to determine whether the current pitch angle βₘₑₐₛ should be locked. If meas is not less than or equal to β_{lock}, normal operation can continue at step 733 and locking does not occur. If βₘₑₐₛ is less than or equal to β_{lock}, the actuation system is commanded, at step 737, to lock the pitch. It will be appreciated that the system 200 continuously and rapidly updates the βₘₑₐₛ value so that in practice, βₘₑₐₛ does not typically fall too much below β_{lock} before the system 200 detects the problem and initiates locking. For instance, the system may be set to transmit sense data with a transmission frequency having a value with the range of 5 milliseconds to 50 milliseconds, or, in some approaches within the range of 10 milliseconds to 20 milliseconds, and to update the αₗᵢₘ, βₗᵢₘ, β_{lock}, and β_{feather} values based on the changing sense data. Typically, the locked state remains until landing, unless overridden by a pilot command.

At step 739, the current pitch angle βₘₑₐₛ continues to be received from the sensing hardware 202 and compared, at step 741, to β_{feather} to determine whether feathering is needed. If βₘₑₐₛ is not less than or equal to β_{feather}, feathering is not needed, and normal operation can continue at step 743. If βₘₑₐₛ is less than or equal to β_{feather}, the actuation system is commanded, at step 745, to feather the pitch. If locking has already been initiated, the command to feather the pitch overrides the locking.

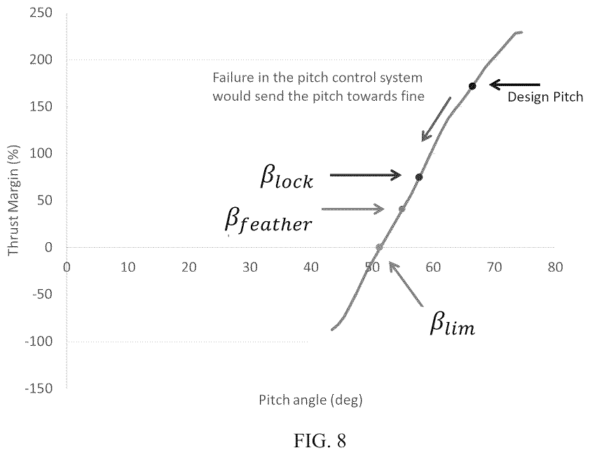

FIG. 8 shows a graphical illustration of an example of βₗᵢₘ, β_{lock}, and β_{feather} relative to thrust margin %, where thrust margin can be expressed by Equation 12:

$$Thrust Margin = \frac{{T}_{design} - {D}_{lim}}{{D}_{lim}} \qquad Equation 12$$

where T_{design} is the design thrust, and Dₗᵢₘ is the limit drag or excessive drag. As shown in FIG. 8, a design pitch at a nominal operating condition may produce a relatively large thrust margin % (e.g., more than 150%). In this example, however, a failure (e.g., in the pitch control system or other engine failure) may result in aerodynamic forces naturally driving the pitch angle towards fine, reducing the thrust margin %. βₗᵢₘ, β_{lock}, and β_{feather} are determined by the system 200 and used to perform mitigation measures if needed if the pitch gets too close to βₗᵢₘ and 0% thrust margin, which causes Dₗᵢₘ. Thus, the system 200 can control the pitch to prevent the thrust margin % from reducing to the point where excessive drag Dₗᵢₘ results and thrust is lost.

In this example, air data and engine data such as pitch angle and fan rotational blade speed are constantly being sensed, and parameters associated with the fixed propeller design are known (e.g., r, A, C_{T0}, C_{Tα}, mentioned above). In this particular example, the altitude is 40,000 ft, the Mach number is 0.8, and the density is estimated using the air data sensors. These values are used to determine βₗᵢₘ, β_{lock}, and β_{feather} as defined above. When the system 200 detects that the pitch has fallen to β_{lock}, the engine controller commands the pitch to be locked. If the problem continues and the pitch angle decreases further to β_{feather}, the engine controller commands the pitch to be feathered. Because β_{lock} and β_{feather} incorporate sufficient margin to account for hardware responsiveness and delays, the mitigation measures are commanded with sufficient time to be executed so that βₗᵢₘ and limit drag is never reached.

In some approaches, β_{lock} and β_{feather} are precisely determined to provide sufficient margin and time to respond to a failure, such that if β_{lock} and β_{feather} were any lower, the system would be at risk of not having sufficient time to respond to a failure, generating limit drag. In some approaches, β_{lock} and β_{feather} could be set to be higher than needed. However, these values should not be set so high as to over-constrain operation.

In other approaches, one or more β_{lock} or β_{feather} are pitch angle values that represent minimum safe pitch angle values, such that threshold mitigation measures are triggered only when the pitch angle is detected below these values. Likewise, in some approaches βₗᵢₘ may represent a minimum safe pitch angle value, such that excessive drag results when the pitch angle drops below this value.

From the foregoing disclosure it is clear that the low pitch protection control systems and methods described herein provide several advantages over current low pitch protection systems. Specifically, the low pitch protection control systems and methods provide a flexible low in-flight pitch threshold that acts as a safeguard to prevent excessive drag generation at the propeller to keep the engine-aircraft out of hazardous conditions such as lateral flight instability associated with excessive drag while reducing or eliminating false negative and false positive activation of mitigation measures associated with use of a static minimum pitch threshold.

Further aspects of the disclosure are provided by the subject matter of the following clauses:

A low pitch protection control system including a plurality of sensors associated with a turbine engine of an aircraft and positioned to generate sensed data related to current operational conditions of the aircraft during flight; a pitch actuation system for variable pitch fan blades of the turbine engine to control a pitch angle of the variable pitch fan blades; and an engine controller electrically coupled to the plurality of sensors and the pitch actuation system, the engine controller including a processor and a memory storing one or more program instructions executable by the processor to: determine, based on at least some of the sensed data from the plurality of sensors, a first pitch angle threshold value for initiating a first mitigating action to prevent onset of excessive drag at the current operational conditions; monitor a current pitch angle of the variable pitch fan blades relative to the first pitch angle threshold value; and command the pitch actuation system to perform the first mitigating action in response to the current pitch angle being less than or equal to the first pitch angle threshold value.

The low pitch protection control system of any preceding clauses, wherein the plurality of sensors includes a Mach number sensor, a rotational speed sensor positioned to sense a rotational speed of the variable pitch fan blades, and a pitch angle position sensor positioned to sense a pitch angle of the variable pitch fan blades.

The low pitch protection control system of any preceding clauses, wherein the at least some of the sensed data used to determine the first pitch angle threshold value includes a current Mach number from a Mach number sensor and a current rotational speed of the variable pitch fan blades from a rotational speed sensor.

The low pitch protection control system of any preceding clauses, wherein the first pitch angle threshold value incorporates a margin based at least in part on a slew rate of the system so that there is sufficient margin for performing the first mitigating action before a limit pitch angle βₗᵢₘ corresponding to excessive drag at the current conditions is reached.

The low pitch protection control system of any preceding clauses, wherein the first pitch angle threshold value is determined at least in part based on a limit pitch angle βₗᵢₘ that results in excessive drag at the current conditions, wherein:

$${β}_{lim} = {α}_{lim} + a tan ( \frac{M a}{( {NF}_{meas} ) r} )$$

where r is a fan radius of the fan blades, NFₘₑₐₛ is a current fan rotational speed of the fan blades, Mis the current Mach number, a is the speed of sound, and αₗᵢₘ is a limit angle of attack that triggers excessive drag at the current conditions.

The low pitch protection control system of any preceding clauses, wherein βₗᵢₘ is determined by the processor prior to determining the first pitch angle threshold value, and the processor confirms whether β_{floor}≤βₗᵢₘ≤β_{roof}, wherein:

$${β}_{roof} = {α}_{lim} + a tan ( \frac{M a}{( {NF}_{idle} ) r} )$$

$${β}_{floor} = {α}_{lim} + a tan ( \frac{M a}{( {NF}_{mp} ) r} )$$

where r is a fan radius of the fan blades, NF_{Idle} is a rotational speed of the fan blades corresponding to an idle state, NFₘₚ is a rotational speed of the fan blades corresponding to a maximum power state, M is the current Mach number, a is the speed of sound, and αₗᵢₘ is a limit angle of attack that triggers excessive drag at the current conditions.

The low pitch protection control system of any preceding clauses, wherein αₗᵢₘ is determined by the processor such that:

$${α}_{lim} = \frac{[ \frac{2 {D}_{lim}}{ρ {NF}_{meas}^{2} {r}^{2} A} - {C}_{T 0} ]}{{C}_{T α}}$$

where r is the fan radius of the fan blades, NFₘₑₐₛ a current fan rotational speed of the fan blades, ρ is air density at operating conditions, A is a cross-sectional area of the fan blades, Dₗᵢₘ is a predefined amount of drag corresponding to excessive drag, C_{T0} is a thrust coefficient at zero angle of attack, and C_{Tα} is an angle-dependent thrust coefficient.

The low pitch protection control system of any preceding clauses, wherein the first mitigating action comprises the pitch actuation system locking the variable pitch fan blades at the current pitch angle.

The low pitch protection control system of any preceding clauses, wherein the processer further determines a second pitch angle threshold value for initiating a second mitigating action to prevent onset of excessive drag at the current conditions, and when the current pitch angle is less than or equal to the second pitch angle threshold value, the engine controller commands the pitch actuation system to initiate the second mitigating action, which comprises feathering the pitch angle of the variable pitch fan blades.

The low pitch protection control system of any preceding clauses, wherein the first mitigating action comprises the pitch actuation system feathering the pitch angle of the variable pitch fan blades.

The low pitch protection control system of any preceding clauses, wherein the turbine engine is an unducted variable speed turbine engine.

A low pitch protection control method including: receiving, at an engine controller, sensed data from a plurality of sensors associated with a turbine engine, the sensed data related to current operational conditions of the turbine engine during flight; determining, via the engine controller, based on at least some of the sensed data from the plurality of sensors, a first pitch angle threshold value for initiating a first mitigating action to prevent onset of excessive drag at the current operational conditions; monitoring, via the engine controller, a current pitch angle of one or more variable pitch fan blades of the turbine engine relative to the first pitch angle threshold value; and commanding a pitch actuation system to perform the first mitigating action in response to the current pitch angle being less than or equal to the first pitch angle value, wherein the pitch actuation system controls a pitch angle of the one or more variable pitch fan blades.

The low pitch protection control method of any preceding clauses, wherein the plurality of sensors includes a Mach number sensor, a rotational speed sensor positioned to sense a rotational speed of the variable pitch fan blades, and a pitch angle position sensor positioned to sense a pitch angle of the variable pitch fan blades.

The low pitch protection control method of any preceding clauses, wherein the first pitch angle threshold value incorporates a margin based at least in part on a slew rate of the system so that there is sufficient margin for performing the first mitigating action before a limit pitch angle βₗᵢₘ corresponding to excessive drag at the current conditions is reached.

The low pitch protection control method of any preceding clauses, wherein the first pitch angle threshold value is determined at least in part based on a limit pitch angle βₗᵢₘ that results in excessive drag at the current conditions, wherein:

$${β}_{lim} = {α}_{lim} + a tan ( \frac{M a}{( {NF}_{meas} ) r} )$$

where r is a fan radius of the fan blades, NFₘₑₐₛ is a current fan rotational speed of the fan blades, Mis the current Mach number, a is the speed of sound, and αₗᵢₘ is a limit angle of attack that triggers excessive drag at the current conditions.

The low pitch protection control method of any preceding clauses, wherein the engine controller further determines αₗᵢₘ wherein:

$${α}_{lim} = \frac{[ \frac{2 {D}_{lim}}{ρ {NF}_{meas}^{2} {r}^{2} A} - {C}_{T 0} ]}{{C}_{T α}}$$

where r is the fan radius of the fan blades, NFₘₑₐₛ a current fan rotational speed of the fan blades, ρ is air density at operating conditions, A is a cross-sectional area of the fan blades, Dₗᵢₘ is a predefined amount of drag corresponding to excessive drag, C_{T0} is a thrust coefficient at zero angle of attack, and C_{Tα} is an angle-dependent thrust coefficient.

The low pitch protection control method of any preceding clauses, wherein the first mitigating action comprises the pitch actuation system locking the variable pitch fan blades at the current pitch angle.

The low pitch protection control method of any preceding clauses, wherein the engine controller further determines a second pitch angle threshold value for initiating a second mitigating action to prevent onset of excessive drag at the current conditions, and when the current pitch angle is less than or equal to the second pitch angle threshold value, the engine controller commands the pitch actuation system to initiate the second mitigating action, which comprises feathering the pitch angle of the variable pitch fan blades.

The low pitch protection control method of any preceding clauses, wherein the first mitigating action comprises the pitch actuation system feathering the pitch angle of the variable pitch fan blades.

The low pitch protection control method of any preceding clauses, wherein the turbine engine is an unducted variable speed turbine engine.

1. A low pitch protection control system comprising:
a plurality of sensors associated with a turbine engine of an aircraft and positioned to generate sensed data related to current operational conditions of the aircraft during flight;
a pitch actuation system for variable pitch fan blades of the turbine engine to control a pitch angle of the variable pitch fan blades; and
an engine controller electrically coupled to the plurality of sensors and the pitch actuation system, the engine controller comprising a processor and a memory storing one or more program instructions executable by the processor to:
determine, based on at least some of the sensed data from the plurality of sensors, a first pitch angle threshold value for initiating a first mitigating action to prevent onset of excessive drag at the current operational conditions;
monitor a current pitch angle of the variable pitch fan blades relative to the first pitch angle threshold value; and
command the pitch actuation system to perform the first mitigating action in response to the current pitch angle being less than or equal to the first pitch angle threshold value.

2. The low pitch protection control system of claim 1, wherein the plurality of sensors includes a Mach number sensor, a rotational speed sensor positioned to sense a rotational speed of the variable pitch fan blades, and a pitch angle position sensor positioned to sense a pitch angle of the variable pitch fan blades.

3. The low pitch protection control system of claim 1, wherein the at least some of the sensed data used to determine the first pitch angle threshold value includes a current Mach number from a Mach number sensor and a current rotational speed of the variable pitch fan blades from a rotational speed sensor.

4. The low pitch protection control system of claim 1, wherein the first pitch angle threshold value incorporates a margin based at least in part on a slew rate of the system so that there is sufficient margin for performing the first mitigating action before a limit pitch angle βₗᵢₘ corresponding to excessive drag at the current operational conditions is reached.

5. (canceled)

6. (canceled)

7. (canceled)

8. The low pitch protection control system of claim 1, wherein the first mitigating action comprises the pitch actuation system locking the variable pitch fan blades at the current pitch angle.

9. The low pitch protection control system of claim 8, wherein the processer further determines a second pitch angle threshold value for initiating a second mitigating action to prevent onset of excessive drag at the current operational conditions, and when the current pitch angle is less than or equal to the second pitch angle threshold value, the engine controller commands the pitch actuation system to initiate the second mitigating action, which comprises feathering the pitch angle of the variable pitch fan blades.

10. The low pitch protection control system of claim 1, wherein the first mitigating action comprises the pitch actuation system feathering the pitch angle of the variable pitch fan blades.

11. The low pitch protection control system of claim 1, wherein the turbine engine is an unducted variable speed turbine engine.

12. A low pitch protection control method comprising:
receiving, at an engine controller, sensed data from a plurality of sensors associated with a turbine engine, the sensed data related to current operational conditions of the turbine engine during flight;
determining, via the engine controller, based on at least some of the sensed data from the plurality of sensors, a first pitch angle threshold value for initiating a first mitigating action to prevent onset of excessive drag at the current operational conditions;
monitoring, via the engine controller, a current pitch angle of one or more variable pitch fan blades of the turbine engine relative to the first pitch angle threshold value; and
commanding a pitch actuation system to perform the first mitigating action in response to the current pitch angle being less than or equal to the first pitch angle value, wherein the pitch actuation system controls a pitch angle of the one or more variable pitch fan blades.

13. The method of claim 12, wherein the plurality of sensors includes a Mach number sensor, a rotational speed sensor positioned to sense a rotational speed of the variable pitch fan blades, and a pitch angle position sensor positioned to sense a pitch angle of the variable pitch fan blades.

14. The method of claim 12, wherein the first pitch angle threshold value incorporates a margin based at least in part on a slew rate of the system so that there is sufficient margin for performing the first mitigating action before a limit pitch angle βₗᵢₘ corresponding to excessive drag at the current operational conditions is reached.

15. (canceled)

16. (canceled)

17. The method of claim 12, wherein the first mitigating action comprises the pitch actuation system locking the variable pitch fan blades at the current pitch angle.

18. The method of claim 17, wherein the engine controller further determines a second pitch angle threshold value for initiating a second mitigating action to prevent onset of excessive drag at the current operational conditions, and when the current pitch angle is less than or equal to the second pitch angle threshold value, the engine controller commands the pitch actuation system to initiate the second mitigating action, which comprises feathering the pitch angle of the variable pitch fan blades.

19. The method of claim 12, wherein the first mitigating action comprises the pitch actuation system feathering the pitch angle of the variable pitch fan blades.

20. The method of claim 12, wherein the turbine engine is an unducted variable speed turbine engine.

21. The method of claim 12, wherein the at least some of the sensed data used to determine the first pitch angle threshold value includes a current Mach number from a Mach number sensor and a current rotational speed of the variable pitch fan blades from a rotational speed sensor.

22. The method of claim 18, wherein the second pitch angle threshold value is less than the first pitch angle threshold value, and the second mitigating action overrides the first mitigating action if the first mitigating action has already been initiated.

23. The method of claim 18, wherein the engine controller determines a limit pitch angle βₗᵢₘ corresponding to excessive drag at the current operational conditions and the first pitch angle threshold value and the second pitch angle threshold value are determined based on the limit pitch angle βₗᵢₘ, wherein the first pitch angle threshold value and the second pitch angle threshold value each incorporate sufficient margin above the limit pitch angle βₗᵢₘ so the first mitigating action and the second mitigating action can be initiated before the limit pitch angle βₗᵢₘ is reached.

24. The low pitch protection control system of claim 9, wherein the second pitch angle threshold value is less than the first pitch angle threshold value, and the second mitigating action overrides the first mitigating action if the first mitigating action has already been initiated.

25. The low pitch protection control system of claim 9, wherein the processor determines a limit pitch angle βₗᵢₘ corresponding to excessive drag at the current operational conditions and the first pitch angle threshold value and the second pitch angle threshold value are determined based on the limit pitch angle βₗᵢₘ, wherein the first pitch angle threshold value and the second pitch angle threshold value each incorporate sufficient margin above the limit pitch angle βₗᵢₘ so the first mitigating action and the second mitigating action can be initiated before the limit pitch angle βₗᵢₘ is reached.
